(19) United States
(12) Patent Application Publication
(10) Pub. No.: US 2024/0138439 A1
(43) Pub. Date: May 2, 2024

(54) METHOD AND APPARATUS FOR ALIGNING CAKE DISCS IN THE DECORATION OF A CONFECTION

(71) Applicant: Timothy Black, La Mesa, CA (US)

(72) Inventor: Timothy Black, La Mesa, CA (US)

(21) Appl. No.: 17/978,126

(22) Filed: Oct. 31, 2022

(51) Int. Cl. A23G 7/00; A23G 3/28; A23G 3/34

(52) U.S. Cl. CPC A23G 7/0025; A23G 3/0097; A23G 3/28; A23G 7/0037; A23G 2220/20

(57) ABSTRACT

A cake decoration jig for coaxially aligning cake discs and a confection such that the confection can be decorated using the cake discs and a scraper includes a base wall with a support surface, a first side wall with a first alignment surface, and a second side wall with a second alignment surface. Each of the support surface, the first alignment surface, and the second alignment surface are planar. The support surface is oriented horizontally, and each of the first alignment surface and the second alignment surface are perpendicular to the support surface and to each other. The cake decoration jig is used in a new method for coaxially aligning cake discs with a confection.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cake decoration jigs and more particularly pertains to a new cake decoration jig for coaxially aligning cake discs and a confection such that the confection can be decorated using the cake discs and a scraper.

### (2) Description of Related Art Including Information Disclosed Under 37 CFR 1.97 and 1.98

The prior art relates to cake decoration jigs, which includes devices which align tiers of a cake with each other and devices which align a knife with a cake to make uniform cuts into the cake.

### BRIEF SUMMARY OF THE INVENTION

An embodiment of the disclosure meets the needs presented above by generally comprising a base wall having a support surface which is planar and oriented horizontally and is configured for supporting items thereon. A first side wall is coupled to and extends upwardly from the base wall. The first side wall has a first alignment surface which is planar. The first alignment surface is also perpendicular to and positioned in abutment with the support surface of the base wall. A second side wall is coupled to and extends upwardly from the base wall. The second side wall is also coupled to and extends from the first side wall. The second side wall has a second alignment surface which is planar. The second alignment surface is also perpendicular to and in abutment with each of the support surface and the first alignment surface.

Another embodiment of the disclosure includes a method comprising positioning a first cake disc on a support surface of a base wall of a cake decoration jig such that a perimeter edge of the first cake disc abuts a first alignment surface of a first side wall of the cake decoration jig and a second alignment surface of a second side wall of the cake decoration jig. The support surface is planar and oriented horizontally, and each of the first alignment surface and the second alignment surface are planar, perpendicular to the support surface, and perpendicular to each other. A confection is positioned coaxially onto the first cake disc, the confection having a size such that the perimeter edge of the first cake disc laterally surrounds the confection. A second cake disc equal in size and shape to the first cake disc is positioned coaxially onto the confection such that a perimeter edge of the second cake disc abuts each of the first alignment surface and the second alignment surface. In this arrangement the first cake disc, the confection, and the second cake disc form a stack.

The stack is removed from the cake decoration jig and positioned on a horizontal surface such that the first cake disc abuts the horizontal surface and remains coaxially aligned with each of the confection and the second cake disc. Icing is spread onto a lateral perimeter surface of the confection such that the icing extends laterally past the perimeter edge of the first cake disc. A scraping edge of a scraper is positioned in abutment with each of the perimeter edge of the first cake disc and the perimeter edge of the second cake disc such that the scraping edge is in a vertical orientation. Then, the scraper is moved along each of the perimeter edge of the first cake disc and the perimeter edge of the second cake disc while maintaining the scraping edge in the vertical orientation to remove a portion of the icing and form a smooth outer surface of the icing. Then the second cake disc is removed from the confection and the confection is removed from the first cake disc.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a cake decoration jig according to an embodiment of the disclosure.

FIG. 2 is a top front side perspective view of an embodiment of the disclosure.

FIG. 3 is a side view of an embodiment of the disclosure.

FIG. 4 is a top view of an embodiment of the disclosure.

FIG. 5 is a perspective in-use view of an embodiment of the disclosure.

FIG. 6 is a view of the confection, the first cake disc, and the second cake disc after being aligned by an embodiment of the disclosure.

### DETAILED DESCRIPTION OF THE INVENTION

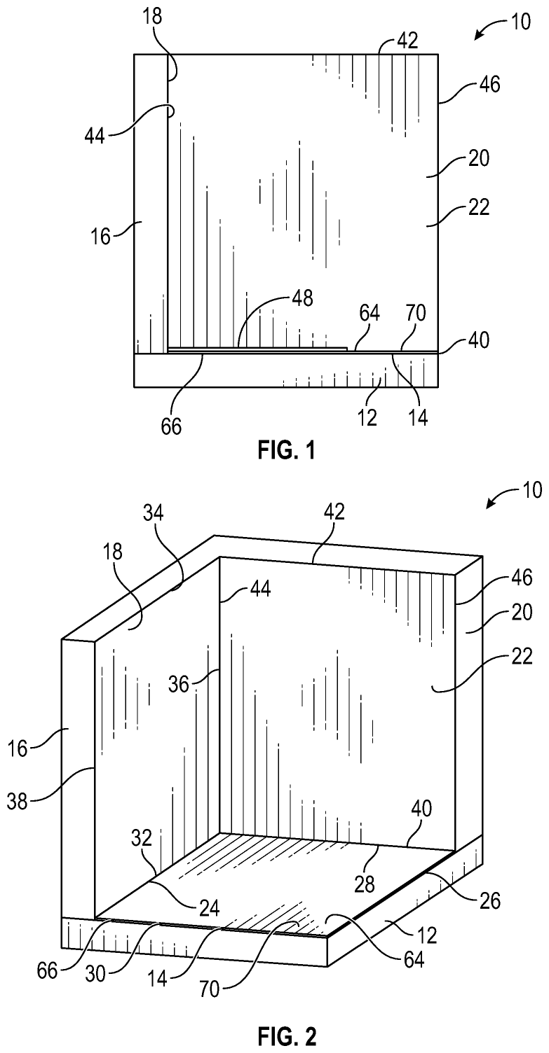

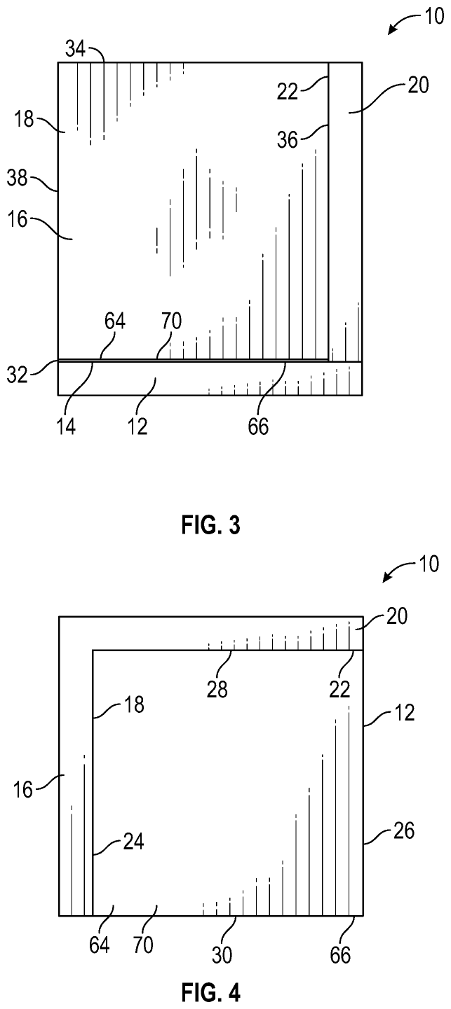

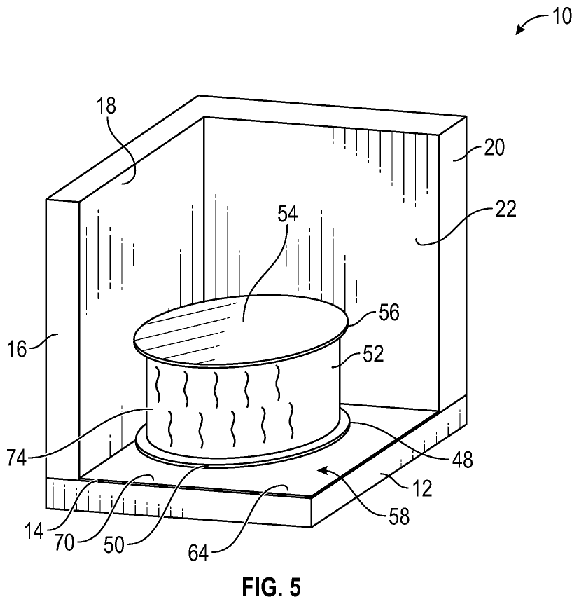

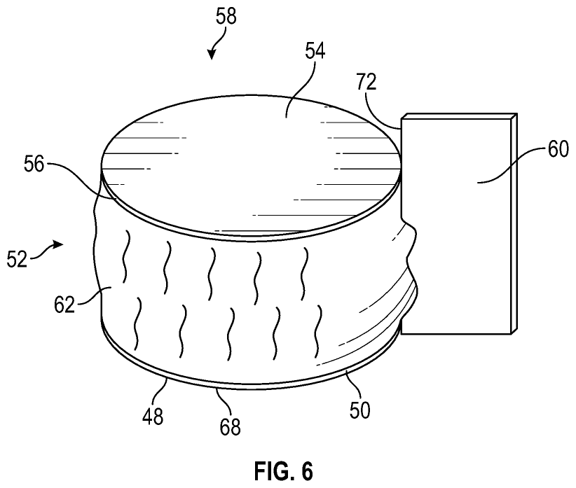

With reference now to the drawings, and in particular to FIGS. 1 through 6 thereof, a new cake decoration jig embodying the principles and concepts of an embodiment of the disclosure and generally designated by the reference numeral 10 will be described.

As best illustrated in FIGS. 1 through 6, the cake decoration jig 10 generally comprises a base wall 12 having a support surface 14 which is planar and oriented horizontally. The support surface 14 is configured for supporting items thereon. A first side wall 16 is coupled to and extends upwardly from the base wall 12. The first side wall 16 has a first alignment surface 18 which is planar. The first alignment surface 18 is also perpendicular to and positioned in abutment with the support surface 14 of the base wall 12. A second side wall 20 is coupled to and extends upwardly from the base wall 12. The second side wall 20 is also coupled to and extends from the first side wall 16. The second side wall 20 has a second alignment surface 22 which is planar. The second alignment surface 22 is also perpendicular to and in abutment with each of the support surface 14 and the first alignment surface 18.

The support surface 14 has a width from a proximal edge 24 relative to the first side wall 16 to a distal edge 26 relative to the first side wall 16 of between 6.0 inches and 18.0 inches and a length from a proximal edge 28 relative to the second side wall 20 to a distal edge 30 of the side wall of between 6.0 inches and 18.0 inches. The first alignment surface 18 has a height from a proximal edge 32 relative to the base wall 12 to a distal edge 34 relative to the base wall 12 of between 6.0 inches and 18.0 inches and a length from a proximal edge 36 relative to the second side wall 20 to a distal edge 38 relative to the second side wall 20 of between 6.0 and 18.0 inches. The second alignment surface 22 has a height from a proximal edge 40 relative to the base wall 12 to a distal edge 42 relative to the base wall 12 of between 6.0 inches and 18.0 inches and a width from a proximal edge 44 relative to the first side wall 16 to a distal edge 46 relative to the first side wall 16 of between 6.0 and 18.0 inches. Each of the support surface 14, the first alignment surface 18, and the second alignment surface 22 may be square and equal in size and shape to each other.

The cake decoration jig 10 is used in conjunction with a pair of cake discs and a scraper 60. A “cake disc,” as used in this disclosure including the claims, describes a plate used in pairs and with the scraper 60 to create circumferentially uniform surfaces in icing 62 on a lateral perimeter surface 74 of a confection 52. While including the term “disc,” the cross-sectional shape of a cake disc does not need to be circular or rounded and can have any two-dimensional shape including, for example, a rectangle. The scraper 60 may have a straight scraping edge 72 or may follow a more complex path.

In use, a first cake disc 48 is positioned on the support surface 14 such that a perimeter edge 50 of the first cake disc 48 abuts the first alignment surface 18 and the second alignment surface 22. Then a confection 52 is positioned coaxially onto the first cake disc 48, the confection 52 having a size such that the perimeter edge 50 of the first cake disc 48 laterally surrounds the confection 52. A second cake disc 54 being equal in size and shape to the first cake disc 48 is positioned onto the confection 52 such that a perimeter edge 56 of the second cake disc 54 abuts each of the first alignment surface 18 and the second alignment surface 22. The first cake disc 48, the confection 52, and the second cake disc 54 form a stack 58 that can be removed from the cake decoration jig 10 to form icing 62 on the confection 52 using the first cake disc 48, the second cake disc 54, and the scraper 60.

A sheet 64 may also be placed between the first cake disc 48 and the support surface 14 to facilitate moving the stack 58 away from the first alignment surface 18 and the second alignment surface 22. This may include pulling the sheet 64 such that the stack 58 hangs over a peripheral edge 66 of the support surface 14, which facilitates the positioning of a support member in engagement with a bottom surface 68 of the first cake disc 48. The support member may be a hand of a user, a tray, or the like for moving the stack to a horizontal surface where the confection 52 may be iced without interference with the cake decoration jig 10. The support member may also be the horizontal surface itself. The sheet 64 may be a piece of parchment paper 70, aluminum foil, a tray, or like support means which is positionable between the first cake disc 48 and the support surface 14 without altering the orientation of the stack 58 and which facilitates moving the stack 58.

The icing 62 is formed on the confection 52 by placing the stack 58 onto a horizontal surface such that the first cake disc 48 abuts the horizontal surface and remains coaxially aligned with each of the confection 52 and the second cake disc 54. The icing 62 is spread onto a lateral perimeter surface 74 of the confection 52 such that the icing 62 extends laterally past the perimeter edge 50 of the first cake disc 48. The scraping edge 72 of a scraper 60 is positioned in abutment with each of the perimeter edge 50 of the first cake disc 48 and the perimeter edge 56 of the second cake disc 54 such that the scraping edge 72 is in a vertical orientation. Then, the scraper 60 is moved along each of the perimeter edge 50 of the first cake disc 48 and the perimeter edge 56 of the second cake disc 54 while maintaining the scraping edge 72 in the vertical orientation to remove a portion of the icing 62 and form a smooth outer surface of the icing 62. Then the second cake disc 54 is removed from the confection 52 and the confection 52 is removed from the first cake disc 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cake decoration jig comprising:
a base wall having a support surface being planar and oriented horizontally, the support surface being configured for supporting items thereon;
a first side wall being coupled to and extending upwardly from the base wall, the first side wall having a first alignment surface being planar, the first alignment surface being perpendicular to and in abutment with the support surface of the base wall; and
a second side wall being coupled to and extending upwardly from the base wall, the second side wall being coupled to and extending from the first side wall, the second side wall having a second alignment surface being planar, the second alignment surface being perpendicular to and in abutment with each of the support surface and the first alignment surface.

2. The jig of claim 1, wherein the support surface has a width from a proximal edge relative to the first side wall to a distal edge relative to the first side wall of between 6.0 inches and 18.0 inches, the support surface having a length from a proximal edge relative to the second side wall to a distal edge of the side wall of between 6.0 inches and 18.0 inches.

3. The jig of claim 1, wherein the first alignment surface has a height from a proximal edge relative to the base wall to a distal edge relative to the base wall of between 6.0 inches and 18.0 inches, the first alignment surface having a length from a proximal edge relative to the second side wall to a distal edge relative to the second side wall of between 6.0 and 18.0 inches.

4. The jig of claim 1, wherein the second alignment surface has a height from a proximal edge relative to the base wall to a distal edge relative to the base wall of between 6.0 inches and 18.0 inches, the second alignment surface having a width from a proximal edge relative to the first side wall to a distal edge relative to the first side wall of between 6.0 and 18.0 inches.

5. The jig of claim 1, wherein each of the support surface, the first alignment surface, and the second alignment surface is equal in size and shape.

6. The jig of claim 1, wherein each of the support surface, the first alignment surface, and the second alignment surface is square.

7. A cake decoration jig comprising:
a base wall having a support surface being planar and oriented horizontally, the support surface being configured for supporting items thereon;
a first side wall being coupled to and extending upwardly from the base wall, the first side wall having a first alignment surface being planar, the first alignment surface being perpendicular to and in abutment with the support surface of the base wall;
a second side wall being coupled to and extending upwardly from the base wall, the second side wall being coupled to and extending from the first side wall, the second side wall having a second alignment surface being planar, the second alignment surface being perpendicular to and in abutment with each of the support surface and the first alignment surface;
the support surface having a width from a proximal edge relative to the first side wall to a distal edge relative to the first side wall of between 6.0 inches and 18.0 inches, the support surface having a length from a proximal edge relative to the second side wall to a distal edge of the side wall of between 6.0 inches and 18.0 inches;
the first alignment surface having a height from a proximal edge relative to the base wall to a distal edge relative to the base wall of between 6.0 inches and 18.0 inches, the first alignment surface having a length from a proximal edge relative to the second side wall to a distal edge relative to the second side wall of between 6.0 and 18.0 inches;
the second alignment surface having a height from a proximal edge relative to the base wall to a distal edge relative to the base wall of between 6.0 inches and 18.0 inches, the second alignment surface having a width from a proximal edge relative to the first side wall to a distal edge relative to the first side wall of between 6.0 and 18.0 inches;
each of the support surface, the first alignment surface, and the second alignment surface being equal in size and shape to each other; and
each of the support surface, the first alignment surface, and the second alignment surface being square.

8. A method of icing a confection including the steps of:
positioning a first cake disc on a support surface of a base wall of a cake decoration jig such that a perimeter edge of the first cake disc abuts a first alignment surface of a first side wall of the cake decoration jig and a second alignment surface of a second side wall of the cake decoration jig, wherein the support surface is planar and oriented horizontally, wherein each of the first alignment surface and the second alignment surface are planar, perpendicular to the support surface, and perpendicular to each other;
positioning a confection coaxially onto the first cake disc, the confection having a size such that the perimeter edge of the first cake disc laterally surrounds the confection;
positioning a second cake disc coaxially onto the confection, the second cake disc being equal in size and shape to the first cake disc, a perimeter edge of the second cake disc abutting each of the first alignment surface and the second alignment surface, wherein the first cake disc, the confection, and the second cake disc form a stack;
removing the stack from the cake decoration jig and positioning the stack on a horizontal surface such that the first cake disc abuts the horizontal surface and remains coaxially aligned with each of the confection and the second cake disc;
spreading icing onto a lateral perimeter surface of the confection such that the icing extends laterally past the perimeter edge of the first cake disc;
positioning a scraping edge of a scraper in abutment with each of the perimeter edge of the first cake disc and the perimeter edge of the second cake disc such that the scraping edge is in a vertical orientation;
moving the scraper along each of the perimeter edge of the first cake disc and the perimeter edge of the second cake disc while maintaining the scraping edge in the vertical orientation to remove a portion of the icing and form a smooth outer surface of the icing;
removing the second cake disc from the confection; and
removing the confection from the first cake disc.

9. The method of claim 8, wherein:
the step of positioning the first cake disc on the support surface further comprises positioning a sheet between the first cake disc and the support surface; and
the step of removing the stack from the cake decoration jig further comprises pulling the sheet such that the stack is spaced away from the first alignment surface and the second alignment surface.

10. The method of claim 9, wherein the step of removing the stack from the cake decoration jig further comprises pulling the sheet such that the stack hangs over a peripheral edge of the support surface, thereby facilitating positioning of a support member in engagement with a bottom surface of the first cake disc.
